(19) United States
(12) Patent Application Publication
(10) Pub. No.: US 2016/0162878 A1
(43) Pub. Date: Jun. 9, 2016

(54) Mobile Payment Using Point of Sale Generated Barcode

(71) Applicant: Ricardo Verlang Kramer, Calgary (CA)

(72) Inventor: Ricardo Verlang Kramer, Calgary (CA)

(21) Appl. No.: 14/953,290

(22) Filed: Nov. 27, 2015

Related U.S. Application Data
(60) Provisional application No. 62/085,447, filed on Nov. 28, 2014.

(51) Int. Cl. G06Q 20/32; G06K 7/10; G06K 19/06; G06Q 20/20

(52) U.S. Cl. CPC G06Q 20/3276; G06Q 20/20; G06K 7/1095; G06K 19/06028

(57) ABSTRACT

A system and a method of transferring funds from a Client using a mobile device equipped with network connection and a digital camera to a Merchant. The mobile device is linked to the merchant's transaction by a visual element such as a barcode which is generated for each transaction and intermediated by the Payment Provider.

### BACKGROUND

When a customer obtain a product or service from a commercial establishment, he or she has several options for paying for this purchase. Those options include cash, credit cards, debit cards, checks and more recently technologies based on Near Field Communication.

This invention relates to enabling the payment of purchases and the performance of other types of funds transfers using mobile devices. After the purchase is initiated and invoiced, or as a condition to finalize the purchase (and invoicing) or a funds transfer, a visual element such as a Barcode, which encodes an unique transaction identifier is printed or displayed in a screen by the Point-of-sale device.

The Client then uses his or her mobile device's camera to scan this visual element. The mobile device decodes the Transaction Unique Identifier and uses this data to link the mobile device connected to a computer network (such as the Internet via cellular phone data service) to the Payment Provider allowing for the completion of funds transference. Next, both the Client and the merchant are notified about the status of the transaction.

### BRIEF SUMMARY OF THE INVENTION

The present invention comprises a system and a method to enable the transfer of funds from a Client to a Merchant. This system and method uses the Network and visual elements such as Barcodes generated by the Merchant's Point-of-Sale device to link the transaction to the Client's mobile device. The mobile device uses an Application and the digital camera to captures and decode this visual element. Each transaction requires a different visual element and is intermediated by the Payment Provide.

### BRIEF DESCRIPTION OF THE DRAWINGS

FIG. 1. a flowchart describing in high level the overall process

FIG. 2. is a flowchart describing the Client Registration process

FIG. 3 A. is a flowchart describing the initialization process of the Client Purchase/Invoice First method

FIG. 3 B. is a flowchart describing the finalization process of the Client Purchase/Invoice First method

FIG. 4 A. is a flowchart describing the initialization process of the Client Purchase/Payment First method

FIG. 4 B. is a flowchart describing the finalization process of the Client Purchase/Payment First method

FIG. 5 A. is a flowchart describing the Merchant Sale/Invoice First method

FIG. 5 B. is a flowchart describing the Merchant Sale/Payment First method

FIG. 6. is a flowchart describing the interaction between the Payment Provider and the Merchant

FIG. 7. is a flowchart describing the interaction between the Payment Provider and the Client while the Client receiving transaction information

FIG. 8. is a flowchart describing the interaction between the Payment Provider and the Client while Client performing the funds transfer

FIG. 9. is a schematic representation of the data structure used for communicating between Merchant's equipment and Payment Provider and Client's equipment and Payment Provider

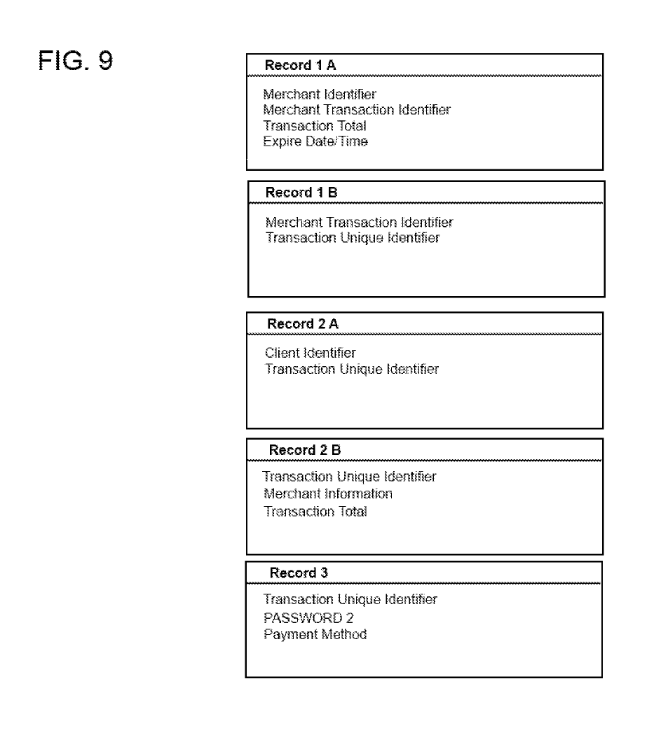

### DETAILED DESCRIPTION OF THE INVENTION

The object of the present invention is a system and method for allowing the payment of purchases and the performance of other funds transfers using mobile devices equipped with a digital camera and network connectivity.

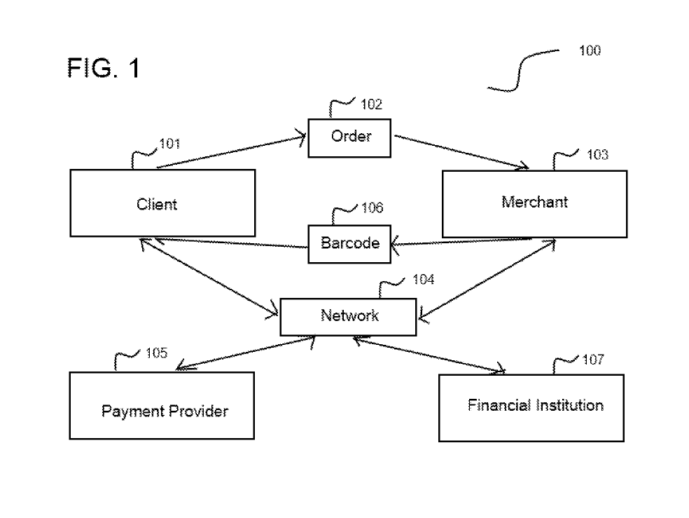

FIG. 1 provides a high level description of the invention. It is assumed that the Client is already registered in the Payment Provider as explained in step 200. The Client (101) creates an Order (102) which consists in any transaction that requires the transference of funds from the Client to the Merchant. This Order includes but is not limited to the purchase of products and services, charitable donations or other funds transfer. The Merchant (103) receives this Order and register the transaction on its Point-of-Sale (POS) system. The item 103 identifies both the Merchant and POS.

The POS communicates with the Payment Provider (105) through the computer network (104) and informs the Payment Provider about the Order. The Payment Provider creates a new Transaction, which is identified by a Transaction Unique Identifier. This Transaction Unique Identifier is a sequence of characters which is unique in the context of the Payment Provider environment. The Payment Provider send this information back to the POS through the Network. It is assumed that the Merchant and its equipment (POS) is already registered and setup in the Payment Provider system.

The POS receives the transaction information from the Payment Provider and encodes the Transaction Unique Identifier into a visual element, from now on referred only as a Barcode, that can be printed in paper and/or displayed in a screen such as a computer monitor. The Merchant (103) makes this Barcode (106) available to the Client. The Client (101) then uses the Application on his or her Mobile Device, such as a smart phone or tablet computer, to activate the digital camera and read and interpret this Barcode, retrieving the Transaction Unique Identifier. The Mobile Device Application communicates with the Payment Provider (105) through the Computer Network (104) and use the Transaction Unique Identifier to retrieve the Transaction Information from the Payment Provider. The Mobile Device Application then displays to the Client the Transaction Information retrieved from the Payment Provider.

After reviewing the Transaction Information in his or her mobile device screen, the Client has the option to continue or cancel the transaction. To continue the transaction, the Client can (a) use a pre-configured payment method, (b) select from a list of pre-configured payment methods or (c) provide a new payment method such as a new credit card number. After selecting the payment method, the Client provides a Password and confirms the transaction.

The Mobile Device Application communicates with the Payment Provider via Computer Network. The Application informs the Payment Provider that the transaction was accepted by the Client, communicating the password given. Also, if a pre-configured method of payment is not being used, the application informs the optional payment method chosen by the Client. The Payment Provider validates the password and if the password is accepted, it then communicates via Computer Network with the Financial Institution (107). If the password is invalid, the Client is allowed to try again.

The Payment Provider retrieves the necessary Client and Merchant's previously configured data and provides the required information in order to process a funds transfer from the Client to the Merchant. The Financial Institution performs the operation and returns the status of the operation to the Payment Provider.

The Payment Provider notifies both the Client and the Merchant via Network about the status of the funds transfer operation. The status of the funds transfer operation can be either a success or failure. If the operation is successful, the Merchant finalizes the Order. If the operation fails, the Client has the option to select another method of payment on the Mobile Device and repeat the operation from the moment that he or she input the password.

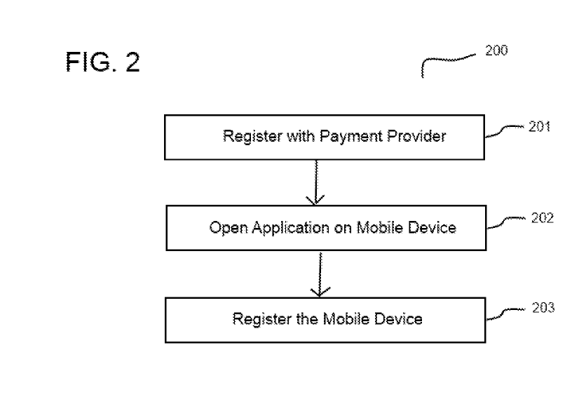

The process for Client Registration described on FIG. 2 starts on step 201, with the Client registering him or herself with the payment provider. This registration process is performed once and will result in the creation of an individual user account. This process can be performed online through a webpage or mobile application where the Client will be asked about the required information. In this step, the Client provides a password called PASSWORD1. This PASSWORD1 is used to access the Client's account by means of resources such as a webpage. This password is also required in order to authenticate the Payment Provider Application in the mobile device. Moreover, during the registration process, the Client will be required to provide a second password, called PASSWORD2. This password is required in step 312 in order to perform each individual transaction. Also in this step, the client can provide a payment information such as credit card or bank account which will be used to withdraw funds.

The Client can now download the Payment Provider's Mobile Application to his or her mobile device. This operation is not required if for some reason the application is already available on the device. Next, in step 202, the Client opens the application in the mobile device and in step 203, provides the registration information received and/or provided in step 201, including the PASSWORD1 when required. The mobile application will communicate with the Payment Provider system and will authenticate the device. The Client will be notified if the mobile device authentication process is not successful. Data regarding the successful registration of the mobile device is stored on the device.

The use of the invention described in this patent can be performed in two modes with minor changes, depending on the nature of the Merchant's business rules.

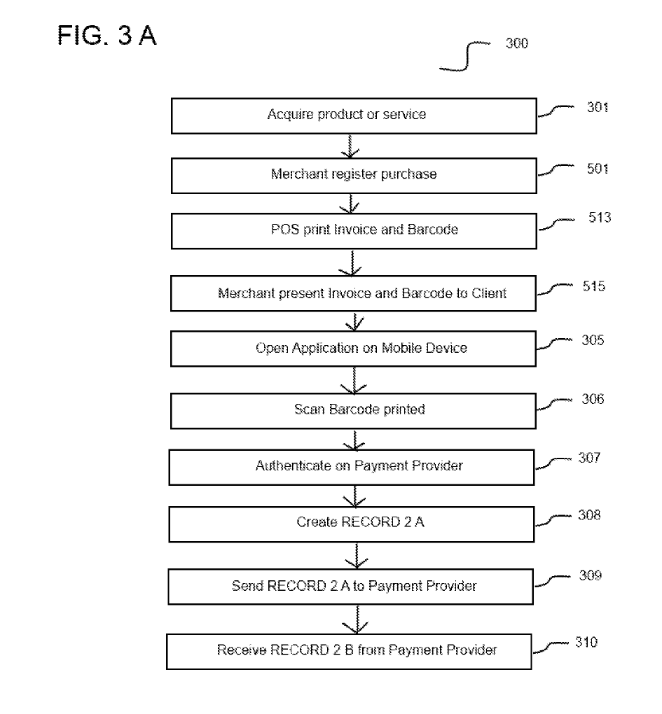

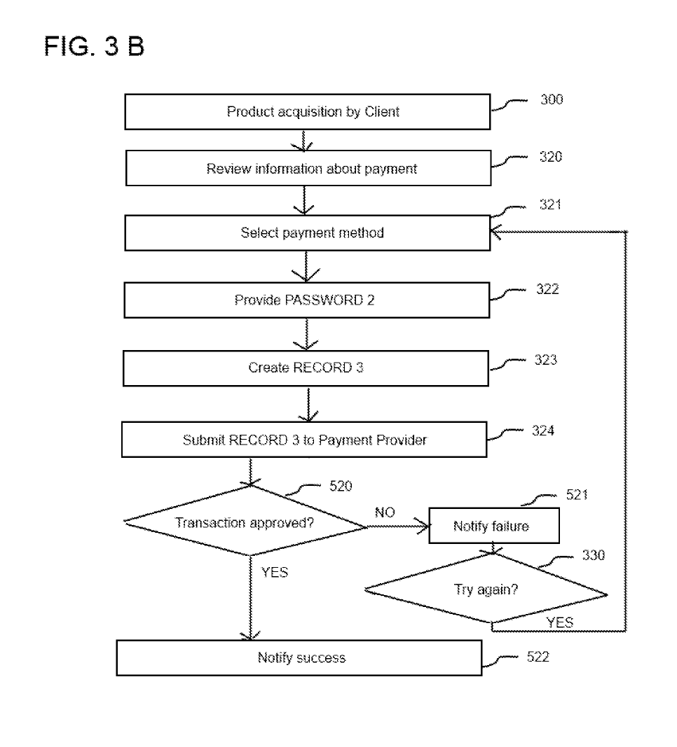

the first mode, called the Invoice First method is described in FIG. 3 A and FIG. 3 B. This method contemplates a use-case scenario where the Client performs a purchase such as a meal in a dine in restaurant where he or she (a) orders and consume the product or service, which is then (b) invoiced and (c) paid. The process starts in step 301, with the Client obtaining the product or service. Next in step 501, the Merchant registers the purchase on the POS system and in step 513, the POS prints the transaction's invoice and Barcode which encodes the Transaction Unique Identifier. This registration in the POS and invoicing process is specific to each merchant. The invoice will he accompanied with a printed Barcode linked to the transaction which can be or not physically attached to the invoice document. The merchant then presents the Invoice and Barcode to the Client (step 515). Alternatively this printed Barcode can be displayed in a screen to the Client.

In step 305, the Client open the application on the mobile device which is already registered as described in step 200. The application uses the digital camera of the mobile device to capture images and display in real-time what is being captured on the mobile device screen. The Client uses this image as a guide in order to target the image of the Barcode provided by the Merchant in step 515. Simultaneously, the application constantly analyzes the images being displayed with the goal of identifying a suitable Barcode.

Once a suitable Barcode is identified (step 306), the application decodes the data encoded on the Barcode. The application then authenticates in the Payment Provider (step 307) and uses the data retrieved from the Barcode and the data stored during the registration time (step 501) to create RECORD 2 A (step 308). The application communicates through the network and sends RECORD 2 A (step 309) to the Payment Provider. The Application then, in step 310, receives as a response RECORD 2 B from the Payment Provider.

Next, the application uses the data received on RECORD 2 B to display, in step 320 information to the Client which includes, but is not limited to the Merchant's identification information and transaction's total.

The Client will in step 321 select a payment method. The Client has the option to (a) cancel the process if desired, (b) select one of the payment methods already provided in step 201 or (c) provide another method of payment, like another credit card number. After the Client select the payment method (options b or c), he or she confirms the transaction. In case the Client cancelled the process (option a), the Merchant is notified and the flowchart is cancelled.

At this moment, in step 322, the Client provides PASSWORD 2 as a second level authentication and confirms that he or she accept the transaction. The application then uses this information in step 323 to create RECORD 3. Next in step 324, the application submits RECORD 3 to the Payment Provider.

The Payment Provider evaluates in step 520 if the transaction can be authorized. If the transaction cannot be approved for any reason, the application then in step 521 notifies the Client and in step 330 and inquires if the Client would like to try again. In case the Client decides to try again, he or she will be redirected to step 321. If the Client decides not to try again, the transaction is canceled. On the other hand, if the transaction is approved, the funds are transferred. The Client and the Merchant are notified of the funds transfer status and the transaction is completed (step 522).

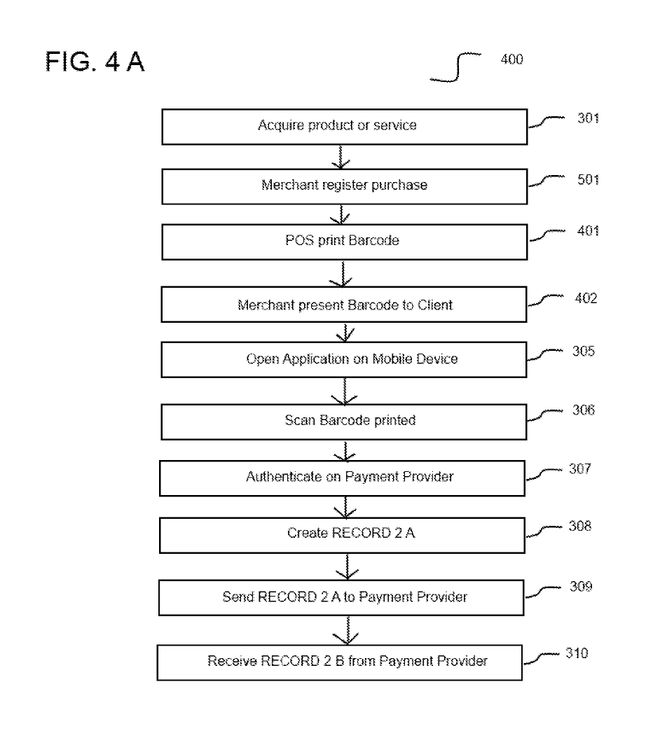

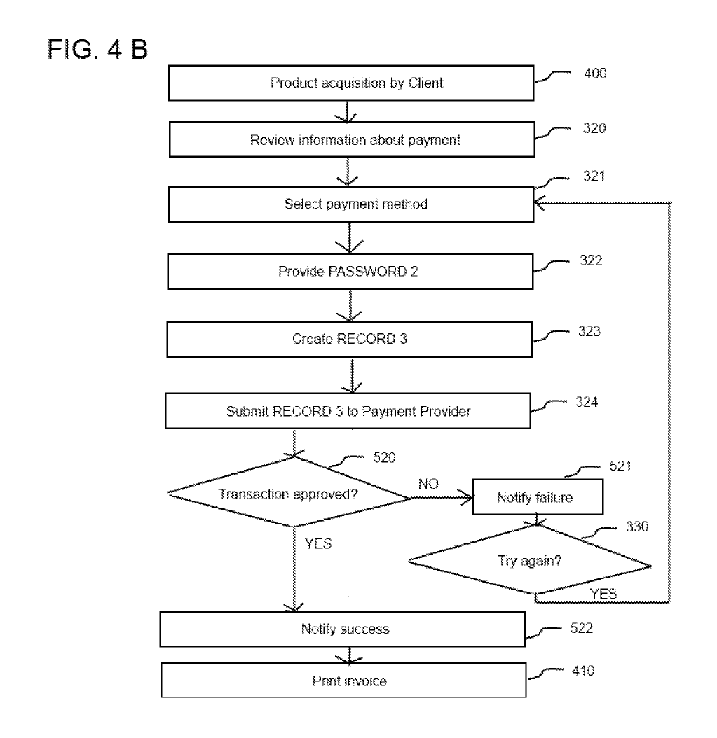

FIG. 4 A and FIG. 4 B—Client Purchase—Payment First contemplates a use-case scenario where the Client performs a purchase such as a meal at a fast-food restaurant where he or she (a) order the product or service, which is then (b) paid and (c) invoiced and later (d) delivered and consumed.

The process is very similar to the process already described in FIG. 3 A and FIG. 3 B with the exception that step 513 in FIG. 3 A is swapped by the step 401 which only prints the Barcode on paper or displays the Barcode in a screen. In the same way, the step 515 in FIG. 3 A is swapped by the step 402 where the Barcode only is presented to the Client. Finally, after the execution of step 522 in FIG. 3 B, the step 410 is executed, where an invoice can be printed and delivered to the Client (based on local legislation and Merchant's business rules).

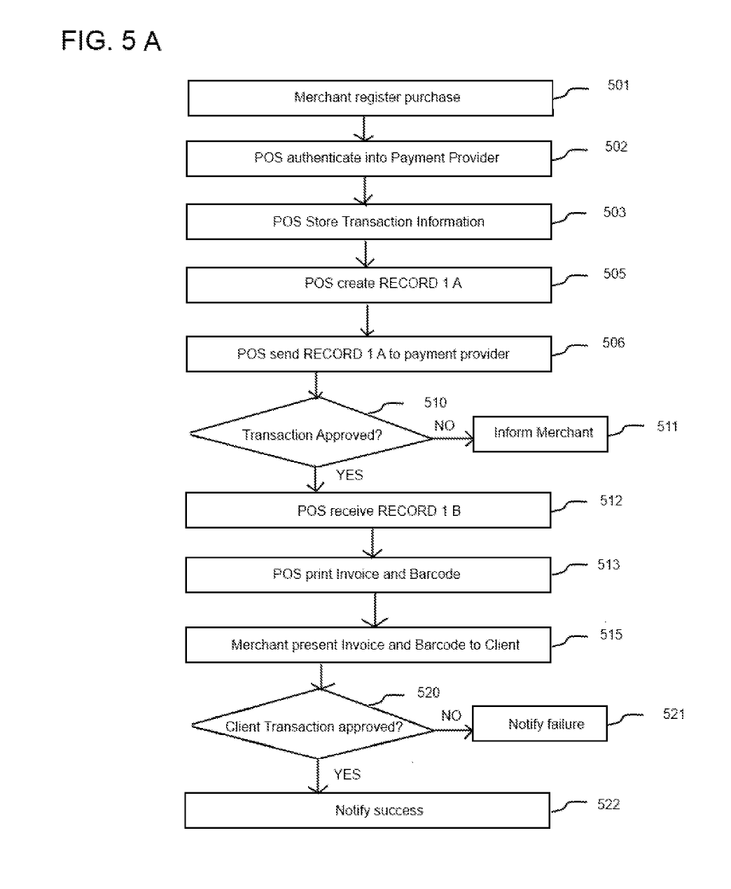

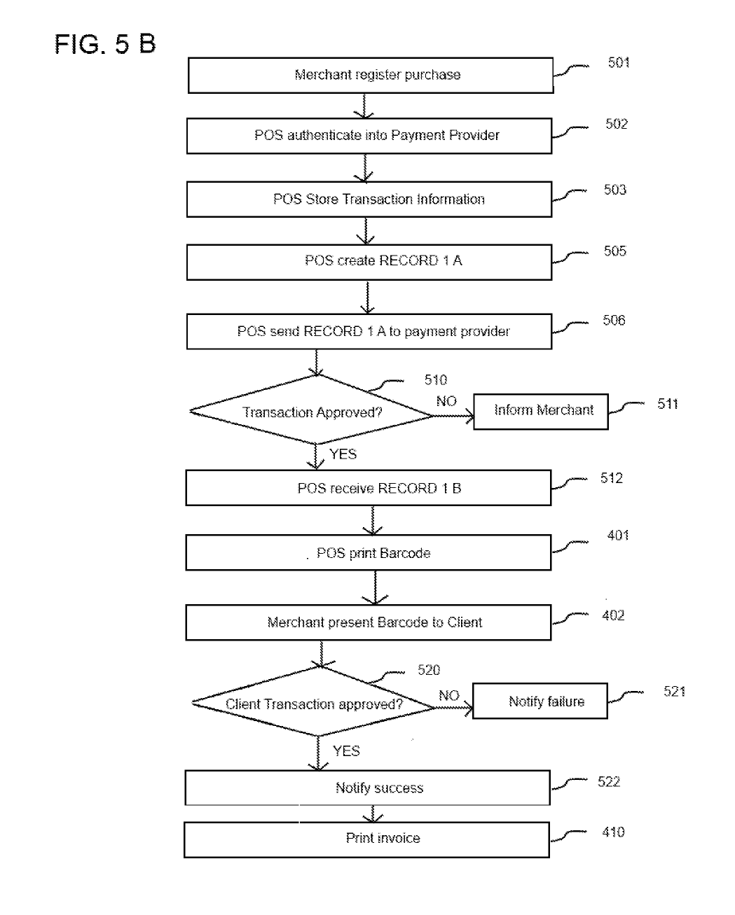

FIG. 5 A shows the Merchant's side of the process performed by the Merchant and the POS with Invoice First method. In the step 501, the Merchant registers the purchase on the POS. This step is performed based on the Merchant's business rules and individual requirements. Then in step 502, the POS authenticates to the Payment Provider. After the authentication is successful, in step 503, the POS stores the transaction information and uses this information to create in step 505 the RECORD 1 A. Next the POS submits this RECORD 1 A to the Payment Provider in step 506.

In step 510, the Payment Provider analyze the information received and decides if a transaction should be created or not. In case a transaction should not be created, the Payment Provider will inform the POS in step 511 about the impossibility of creating the transaction. The POS will handle the impossibility of receiving a funds transfer using this method.

On the other hand, if the transaction is approved, the Payment Provider will create RECORD 1 B and send it to the POS in step 512. Next, in step 513, the POS will print an invoice and also the Barcode that identifies the transaction. This invoice and Barcode will be handed to the Client. Alternatively, the Barcode can be displayed in a screen instead of printed.

The POS then waits in step 520 for the Client to perform his or her side of the transaction. The expected results are either the transaction is approved or not approved. If the transaction is not approved (step 521), the POS is notified about the failure. Contrarily, the POS is notified about the success and the transaction is completed (step 522).

FIG. 5 B show the Merchant's side of the process with Payment First method. This process is very similar to the process already described in FIG. 5 A with the exception that step 513 in FIG. 5 A is swapped by 401 which only displays a Barcode. Also step 515 is swapped by 402 where the Barcode only is presented to the Client. Finally, after the execution of step 522, step 410 is executed, where an invoice is printed and delivered to the Client.

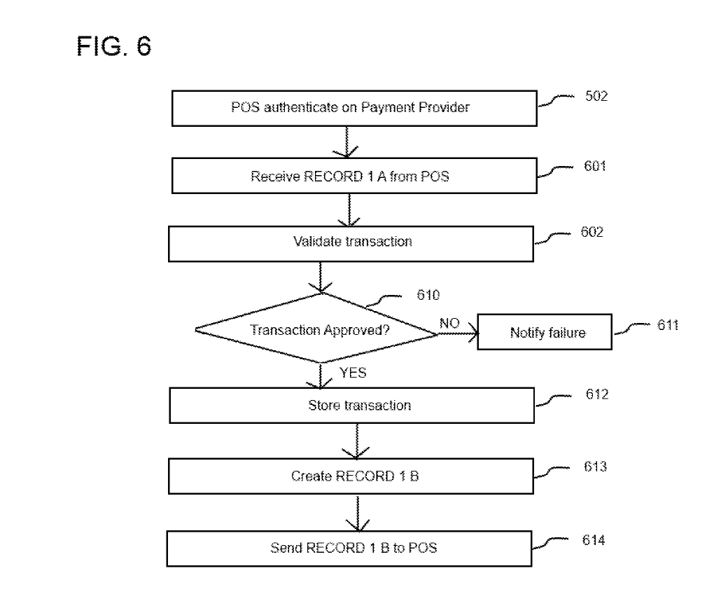

FIG. 6 explains the interaction between the Payment Provider and the Merchant. In step 502, the POS authenticates on the Payment Provider system. The Payment Provider then receive RECORD 1 A from the POS in step 601. Next the Payment Provider validates the information received on RECORD 1 A (step 602).

Then in step 610, the Payment Provider perform checks which decide if the transaction can be approved. Those checks include but are not limited to verifying if the Merchant is authorized to create new transactions. If the transaction is not approved, the POS will be notified in step 611 about the impossibility of creating a new transaction.

On the other hand, in step 612, the Payment Provider will create a new transaction, storing the transaction information and creating RECORD 1 B in step 613. Finally the Payment Provider will submit RECORD 1 B to the POS (step 614).

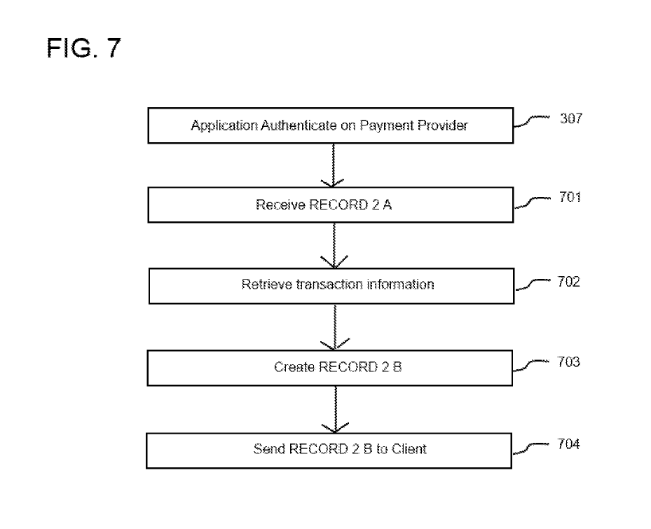

FIG. 7 describes the interaction between the Payment Provider and the Client. In this part of the process, the Client receives information about the transaction being performed. In step 307, the Client's Mobile Application running on the Client's mobile device authenticates to the Payment Provider. Next the Payment Provider receives from the Client's Mobile Application the RECORD 2 A (step 701). The Payment Provider, in step 702, uses the Transaction Unique Identifier to retrieve the transaction information previously stored in step 612. Finally, the Payment Provider creates, in step 703, RECORD 2 B which is sent in step 704 to the Client's Mobile Application.

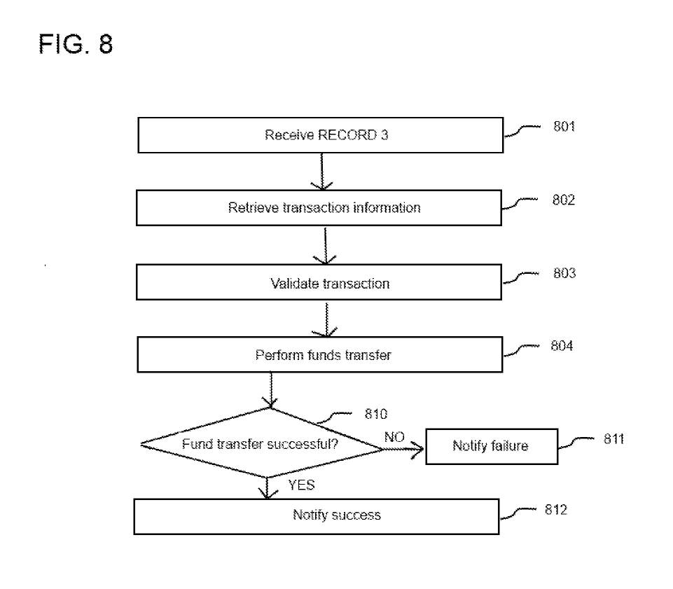

FIG. 8 describes the interaction between the Payment Provider and the Client. In this part of the process, the Client performs the confirmation of the funds transfer. Being already authenticated as this flowchart is a continuation of the flowchart described on FIG. 7, the Client's Mobile Application send the RECORD 3 to the Payment Provider (step 801).

Next, in step 802, the Payment Provider uses the Unique Transaction Identifier present on RECORD 3 to retrieve the transaction information previously stored in step 612. In step 803, the payment provider validates the transaction, checking the consistency of the data available in order to perform the funds transfer.

In step 804, the Payment Provider perform the funds transfer, communicating with the proper Financial Institution. The process of taking funds from the Client's account and depositing them on the Merchant's account is specific for the Financial Institution. The Payment Provider, in step 810, then verifies if the funds transfer is successful. If the funds transfer is not successful then it notifies the failure to the Client and POS (step 811). Contrarily, it notifies in step 812 the Client and POS that the funds transfer was successful and the transaction is completed.

What is claimed:

1. A computer-implemented method of carrying out the payment of commercial transactions and other funds transfers, comprising the steps:
the merchant's point of sale equipment registering a purchase or other funds transfer request and then communicating with the Payment Provider through the Network and informing about the operation;
the creation of a new transaction by the Payment Provider and communicating back to the point of sale which will use the transaction information received from the Payment Provider to generate a visual element such as a Barcode encoding data that can uniquely identify the transaction in the context and which can be printed on paper or displayed in an electronic device's screen;
the Client then uses a mobile device with an application that utilizes the device's digital camera to capture the visual element;
the visual element is captured and decoded by the mobile device and the data extracted is used to link the Payment Provider's transaction to the Client's mobile device, communicating through the Network;
the Client uses the mobile device application to verify the transactions details received from the Payment Provider and optionally select or provide the payment method where the funds will be withdrawn from or use a pre-selected payment method;
the Client provide a password and the mobile application communicates the selection and the password to the Payment Provider via Network;
the Payment Provider can then perform the funds transfer and communicate to both Client and Merchant about the transaction status via Network.
